(19) United States
(12) Patent Application Publication
(10) Pub. No.: US 2003/0021405 A1
(43) Pub. Date: Jan. 30, 2003

(54) System and method for relaying content

(76) Inventors: Craig Durland, Corvallis, OR (US); Edward O. Lee, Corvallis, OR (US); Amy E. Messner, Eugene, OR (US); Timothy P. Justice, Corvallis, OR (US); John R. Milton, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 09/916,041

(22) Filed: Jul. 25, 2001

(51) Int. Cl. H04M 3/00; H04M 11/00

(52) U.S. Cl. 379/243; 379/93.09

(57) ABSTRACT

A system and method are provided for relaying content items such as messages to an individual. In one embodiment, a content relay system implemented, for example, in software includes logic to store a content item in a first format received from a sending device in a memory. Rather than trying to contact an individual via one of many different devices, the content relay system advantageously provides for a single central location that may be contacted. The content relay system also includes logic to identify a select one of a number of recipient devices according to a predefined priority to receive the content item. The content relay system further comprises logic for transmitting the content item to the select one of the recipient devices.

### TECHNICAL FIELD

The present invention is generally related to the field of data communications and, more particularly, is related to a system and method for relaying content items from a source to one of multiple recipient devices.

### BACKGROUND OF THE INVENTION

Communications technology has now made it possible to communicate with an individual almost anywhere at almost any time. To provide an illustration, assume that a particular user, Craig, begins his day at home where he may be contacted via a home telephone. Craig also owns a home computer through which he can send and receive email and a facsimile. As he leaves home, Craig grabs his cellular telephone and a laptop with wireless capability and sets out work. His laptop includes a separate email address from which electronic mail may be sent or received. When Craig gets to the office, he turns on his office computer from which he may send and receive email from a work email address. Also, in his office Craig has an office telephone and a facsimile.

Craig does not spend all of his time at the office on a typical workday. On many days, Craig visits customers and on other days he works at home to avoid a long commute when being in the office is not necessary.

Many individuals might seek to get in touch with Craig throughout the workday for various reasons. Unfortunately, these individuals are faced with a problem. Should they use a telephone, email, or fax to get in touch with Craig? Also, which telephone, email, or fax should they use given there are multiple possibilities for each. Since there are several choices, it might take time to try all the various communications links to contact Craig.

Unfortunately, rather than try all of the various possibilities, chances are a specific individual may only contact Craig's work telephone, for example, and leave a message assuming Craig was not at work. This would be detrimental if the need to contact Craig was urgent.

### SUMMARY OF THE INVENTION

In light of the forgoing, the present invention provides for a system and a method for relaying content items such as messages to an individual. In one embodiment, the system comprises a computer system or other system with a processor circuit having a processor and a memory. The system also includes a content relay system that is implemented, for example, in software that is stored in the memory and executable by the processor. The content relay system also includes logic to store a content item in a first format received from a sending device in the memory. Rather than trying to contact an individual via one of many different devices, the content relay system advantageously provides for a single central location that may be contacted. The content relay system also includes logic to identify a select one of a number of recipient devices according to a predefined priority to receive the content item. The content relay system further comprises logic for transmitting the content item to the select one of the recipient devices.

In another embodiment, the present invention may also be viewed as a method for relaying a content item. In this regard, the present method comprises the steps of storing the content item in a first format received from a sending device in a memory of a content relay server, identifying a select one of a number of recipient devices according to a predefined priority to receive the content item, and, transmitting the content item to the select one of the recipient devices from the content relay server.

The present invention provides distinct advantages in that content items may be sent to an individual at a central location and the content relay system ensures that the content item is forwarded to the recipient wherever they may be. In addition, should one of the recipient devices of the individual be unavailable, the present invention provides for backup recipient devices to which the content item may be transmitted according to a predefined priority. This ensures that the content item has the best chance of reaching the individual to whom it is directed.

Other features and advantages of the present invention will become apparent to a person with ordinary skill in the art in view of the following drawings and detailed description. It is intended that all such additional features and advantages be included herein within the scope of the present invention.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1 is a block diagram of a communications network with several devices linked thereto, the communications network employing a content relay server to facilitate communication among the several devices;

FIG. 2 is an illustration of a graphical user interface generated by the content relay server;

FIG. 3 is a flow chart of a first component of a content relay system executed in the content relay server to relay messages between various ones of the several devices;

FIG. 4 is a flow chart of a second component of the content relay system executed to download the graphical user interface of FIG. 2 to a client in response to a request therefrom; and

FIG. 5 is a flow chart of a third component of the content relay system executed to save priority list data received from a client that is employed to relay messages to the user.

### DETAILED DESCRIPTION OF THE INVENTION

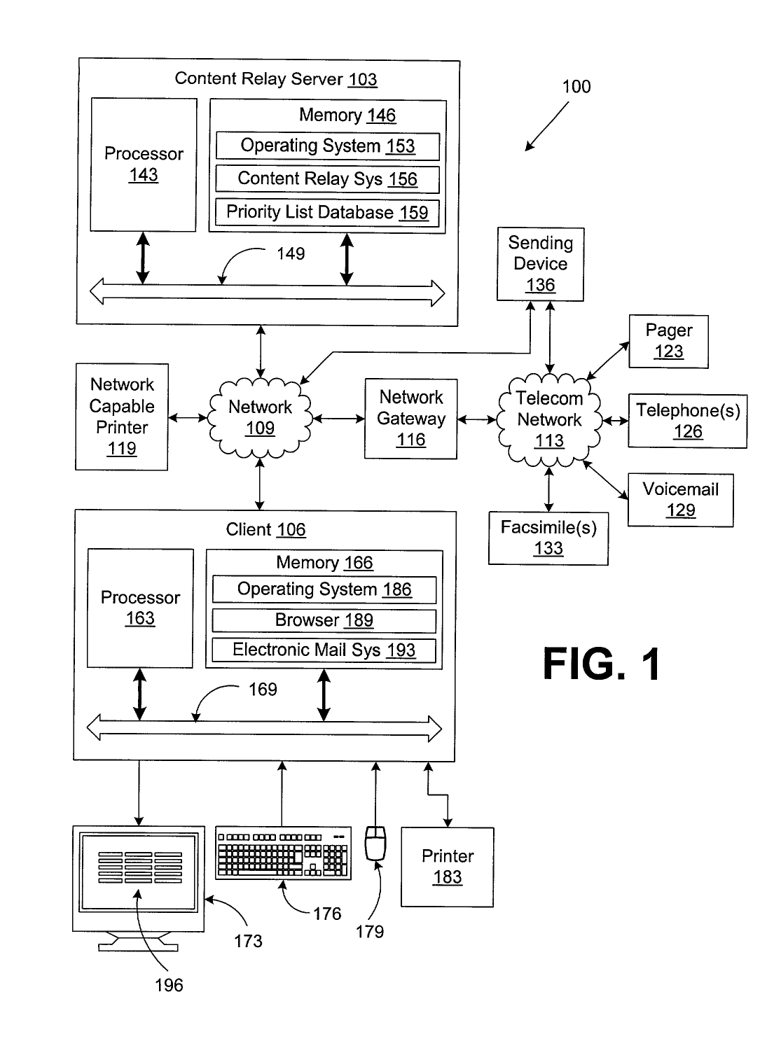

With reference to FIG. 1, shown is a communications network 100 according to an aspect of the present invention. The communications network 100 includes a content relay server 103 and a client 106, both of which are coupled to a network 109. The network 113 may comprise, for example, the Internet, wide area networks (WANs), local area networks, or other suitable networks, etc., or any combination of two or more such networks.

The communications network 100 also includes a telecommunications network 113. The network 109 and the telecommunications network 113 are coupled, for example, by way of a network gateway 116. The communications network 100 also includes a network capable printer 119 that is coupled to the network 109. In addition, coupled to the communications network 100 are a pager 123, one or more telephones 126, a voice mail storage device 129, and one or more facsimiles 133 as well as other devices as is generally known by those with ordinary skill in the art. Each of these devices and the client 106 typically may belong to a specific person as will be described.

In this regard, the telecommunications network 113 may be, for example, the public switched telephone network (PSTN), a digital telephone network, a cellular telephone network, or other network as well as any combination of the foregoing such networks. Thus, the communications network 100 also includes any kind of device that may be linked to such telecommunications networks 113, where the items shown are provided as examples.

The communications network 100 also includes a sending device 136 that may be coupled to either the network 109, the telecommunications network 113, or both networks. In this regard, the sending device 136 may comprise a telephone, pager, facsimile or other device. The sending device 136 may also comprise a client 106 that provides for electronic mail system, etc. Ultimately, the sending device 136 is one that is capable of creating and sending content items such as, for example, messages to a desired recipient.

The content relay server 103 may be, for example, a computer system that includes a processor circuit with a processor 143 and a memory 146, both of which are coupled to a local interface 149. The local interface 149 may be, for example, a data bus with an accompanying control/address bus as is generally known by those with ordinary skill in the art. Stored on the memory 146 and executable by the processor 143 are an operating system 153, a content relay system 156, and a priority list database 159. The specific functionality of the content relay system 156 and the use of the priority list database 159 will be discussed with reference to later text.

The client 106 may also comprise a computer system or other system with similar capability that includes a processor circuit with a processor 163 and a memory 166, both of which are coupled to a local interface 169. The local interface 169 may be, for example, a data bus with an accompanying control/address bus as is generally known by those with ordinary skill in the art. The client 106 also includes a display device 173, a keyboard 176, a mouse 179, and a printer 183. The client 106 may include other peripheral devices, such as, for example keypads, touch pads, touch screens, microphones, scanners, joysticks, indicator lights, speakers, printers, etc. The display device 173 may comprise, for example, a cathode ray tube (CRT), a liquid crystal display screen, a gas plasma-based flat panel display, light emitting diodes, etc.

The client 106 also includes an operating system 186, a browser 189, and an electronic mail system 193. The operating system 186, browser 189, and electronic mail system 193 are all stored on the memory 166 and are executable by the processor 163. By executing the browser 189, for example, the user of the client 106 may access information stored on the content relay server 103 by way of the network 109. For example, the content relay server 103 may serve up one or more websites, graphical user interfaces, or other mark up files that are interpreted by the browser 189 and displayed on the display device as graphical user interfaces 196.

The memories 146 and 166 may include both volatile and nonvolatile memory components. Volatile components are those that do not retain data values upon loss of power. Nonvolatile components are those that retain data upon a loss of power. Thus, each of the memories 146 and 166 may comprise, for example, random access memory (RAM), read-only memory (ROM), hard disk drives, floppy disks accessed via an associated floppy disk drive, compact disks accessed via a compact disk drive, magnetic tapes accessed via an appropriate tape drive, and/or other memory components, or a combination of any two or more of these memory components.

Also, each of the processors 143 and 163 may represent multiple processors and each of the memories 146 and 166 may represent multiple memories that operate in parallel processing circuits, respectively. In such a case, the local interfaces 149 and 169 may be an appropriate network that facilitates communication between any two of the multiple processors or between any processor and any of the memories, etc. The local interfaces 149 and 169 may facilitate memory to memory communication as well. The processors 143/163, memories 146/166, and local interfaces 149/169 may be electrical, optical, or magnetic in nature.

The operating systems 153 and 186 are executed to control the allocation and usage of hardware resources in the content relay server 103 and the client 106, respectively. Specifically, the operating systems 153 and 186 control the allocation and usage of the memory 146 and 166, processing time, and the peripheral devices as well as performing other functionality. In this manner, the operating systems 153 and 186 serve as the foundation on which applications depend as is generally known by those with ordinary skill in the art.

Next the general operation of the content relay system 156 is discussed in connection with the communication's network 100 according to an aspect of the present invention. The content relay server 103 is employed to ensure that a particular individual may receive a content item such as a message no matter where that individual is located. Essentially, the content relay system 156 is executed by the processor 143 in the content relay server 103 to send content items to a particular individual based upon predetermined priority lists stored in the priority list database 159. There may be several priority lists that are associated with each individual in the priority list database 159.

The operation of the content relay system 156 is best described with an illustration to provide context for greater understanding of the present invention. For example, assume that a hypothetical person we will name Susan has three different telephone numbers for three different telephones 126. In particular, Susan has a home telephone, a cellular telephone, and a work telephone. Also assume that Susan has two email addresses for two electronic mail systems 193, one at home and on at work. Finally, Susan has two facsimiles 133, one at home and one at work with a unique telephone number for each.

The content relay system 156 allows Susan to provide individuals with a central telephone number and central email address to which all messages may be addressed in order to communicate a particular content item to her. The sending device 136 sends a content item to the content relay server 103 by way of the central telephone number and/or central email address through the network 109 and/or the telecommunications network 113.

For example, assume that the sending device 136 is a telephone. By calling the central telephone number, the sending device 136 is linked to the network gateway 116 through the telecommunications network 113. The network gateway 116 links the telephone call through the network 109 to the content relay server 103 that can record the spoken audio content from the telephone 126 in the memory 146. In recording the content item from the sender, the content relay system 156 can store the audio signal in the form of a Moving Pictures Experts Group Audio Layer-3 (MP3) file or other file format.

The content relay system 156 then determines precisely where the content that was received is to be communicated to reach Susan. This involves sending the message to one of Susan's above mentioned recipient devices or systems, such as the pager 123, telephone(s) 126, voicemail 129, facsimile(s) 133, or electronic mail systems 193. The question is, to which is the message to be sent?

To determine the particular recipient device to which the content item should be relayed, the content relay system 156 looks up an active priority list stored in the priority list database 159 that is associated with Susan. The active priority list is one of several priority lists associated with Susan that are stored in the priority list database 159. This particular priority list is designated as the “active” priority list among those possible by Susan via an appropriate interface as will be discussed.

The active priority list details the recipient devices belonging to Susan in a particular order of priority as designated by Susan. The content relay system 156 then identifies the recipient device that is at the top of the active priority list and transmits the content item thereto. For example, assuming that the first device listed in the active priority list is Susan's cellular telephone, then the content relay system 156 would establish a communications link with her cellular telephone 126 through the network 109, the network gateway 116, and the telecommunications network 113.

In another example, assume that the recipient device with the highest priority on the active priority list is Susan's home email address. In such case, the content item must be translated from the audio MP3 file into a digital text format that is compatible with Susan's email system 193 in the client 106. The electronic mail is then transmitted to the client 106 via the network 109. Thus, the content relay system 156 includes the ability to translate from one particular content item format to another based upon the format of the sending device and the format required by the selected recipient device.

As was previously stated, Susan can have a number of different priority lists stored within the priority list database 159. Each priority list indicates a different hierarchy of recipient devices that should be contacted. Within a given active priority list, if an attempt to reach a top priority recipient device fails, then the content relay system 156 attempts to transmit the content item to the recipient device with the next lower priority. In this manner, the message is ultimately received by a recipient device belonging to Susan. To determine which of the priority lists is the “active” priority list at any given moment, Susan may interact with the content relay server 103 and select the desired active priority list. Thus, Susan can establish how content items are relayed to her at any give time by selecting a particular priority list as the active priority list, depending upon her location, etc.

In addition, Susan may also change the priority that exists on any of the priority lists stored in the priority list database. For example, Susan may manipulate the browser 189 to interface with the content relay system 156 that generates a graphical user interface 196 that is served to the client 106 and displayed by the browser 189 on the display device 173. The graphical user interface 196 allows Susan to display and alter the various priority lists that are associated with her and stored in the priority list database 159. The graphical user interface 196 also allows Susan to select any one of the priority lists as the current active priority list as well.

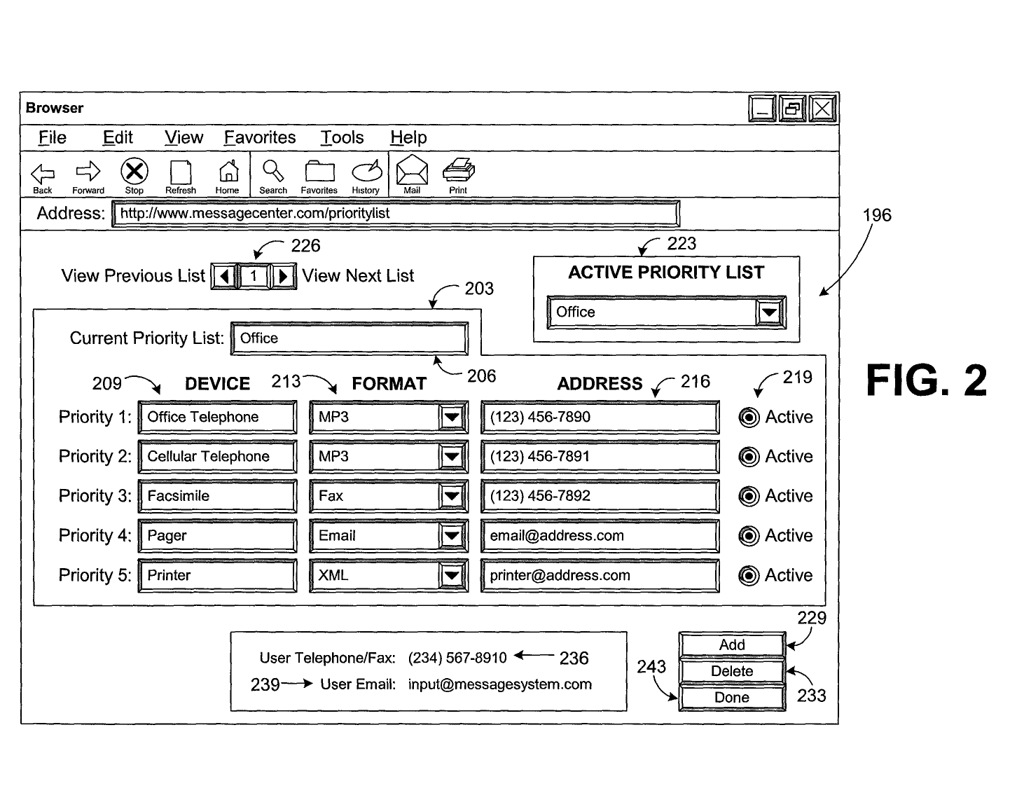

With reference to FIG. 2, shown is a graphical user interface 196 that is generated by the browser 189 (FIG. 1) of the client 106 (FIG. 1) on the display device 173 (FIG. 1) according to an aspect of the present invention. The graphical user interface 196 allows the user to view their associated priority lists, to make changes to these priority lists, and to specify the current active priority list. The graphical user interface 196 may be displayed as part of the browser display as shown in FIG. 2 as is known by those with ordinary skill in the art. In this manner, the graphical user interface 196 is served up from the content relay system 156 (FIG. 1) in response to a request from the browser 189 (FIG. 1) based upon the uniform resource locator (URL) associated with the content relay system 156.

The graphical user interface 196 includes an active priority list 203 that displays a current priority list title 206 and a number of recipient devices 209. The recipient devices 209 are listed according to an order of priority as shown. Associated with each of the recipient devices 209 are a format 213 and an address 216. Also associated with each recipient device 209 is an active indicator 219. The graphical user interface 196 also includes an indicator of the active priority list 223, a list toggle indicator 226, an “add” button 229, a “delete” button 233, and a “done” button 243. Displayed at the bottom of the graphical user interface 196 are a central telephone/facsimile number 236 and a central email address 239 associated with the user.

A user may manipulate the various components of the graphical user interface 196 to display and alter their associated priority lists 203. To manipulate the various components, for example, a user may position a cursor appropriately and “click” on the particular button or enter text, etc.

As stated previously, the priority list 203 indicates several recipient devices 209 listed according to a predefined priority as indicated. When a specific priority list 203 is identified as the active priority list 223 among those possible for a particular user, then all content items received for that individual via the central telephone/facsimile number 236 or the central email address 239 are transmitted to the user according to the current active priority list 223. This reflects the fact that a user may wish to receive content items through different recipient devices 209 based upon the user's location at any given time.

When a user moves from one location to another necessitating a change in the active priority list 223, then the user may access the graphical user interface 196 to designate a different priority list as the active priority list 223. Also, a user may manipulate the graphical user interface 196 to change a particular priority of recipient devices 209 in a displayed priority list 203. By manipulating the list toggle indicator 226, a user can display any one of their priority lists 203. The individual may enter or alter the recipient devices 209 and may select one of a number of available formats 213 that is to be employed with a particular recipient device 209 from a pull down list. Also, the user may enter the address 216 for each of the recipient devices 209.

The addresses entered relate to the nature of the recipient device 209. For example, if the recipient device 209 is a telephone, then the address is a telephone number. If the recipient device 209 is an electronic mail system, then the address is an email address, etc. If the recipient device 209 is currently available in the sense that it is in working order, then the user can click on the active indicator 219 associated therewith. This informs the content relay system 156 whether a particular recipient device 209 is in working order. The content relay system 156 ignores all inactive recipient devices 209, skipping them over when it comes to them during the transmission of a content item.

In addition, the user may add or delete a particular priority list 203 by clicking on the “add” or “delete” buttons 229 and 233, respectively. Specifically, clicking on the “add” button 229 causes the generation of a blank priority list 203 that a user may fill in accordingly. Also, when the “delete” button 233 is clicked, the current priority list 203 displayed is deleted from the priority lists associated with a particular user. By clicking on the “done” button 243, the user may quit the graphical user interface 196 and send the priority lists 203 to the content relay server 103. To change the current active priority list 223 that is employed to transmit content items to the user, a pull down list of the priority lists 203 associated with a user that may be manipulated to make the selection.

With the client 106, the user may manipulate the graphical user interface 196 as shown with respect to FIG. 2 to make various changes to their current priority lists 203 as discussed above. However, in some cases the client 106 may comprise a mini-browser or other system that does not employ the various peripheral devices shown in FIG. 1. In such cases, the client 106 may not be able to render the entire graphical user interface 186. In this situation, portions of the graphical user interface 196 may be downloaded to the particular device employed. For example, assuming that a user employs a mobile device as the client 106 with a mini browser, then only the active priority list 223, for example, may be downloaded thereto to enable the user to switch the active priority list 223. In this respect, any particular device that provides browser access may be employed to manipulate the priority list data for a particular user stored on the priority list database 159 (FIG. 1).

Alternatively, in a case that a user only has access to a telephone without any display and/or browser capability, then an automated voice interface system may be employed to allow a user to switch their current active priority list 223. Specifically, the audio system may provide the various choices of priority lists 203 to the user in a menu driven environment over the telephone 126 (FIG. 1) and the user may respond by pressing the telephone buttons as is generally known by those with ordinary skill in the art.

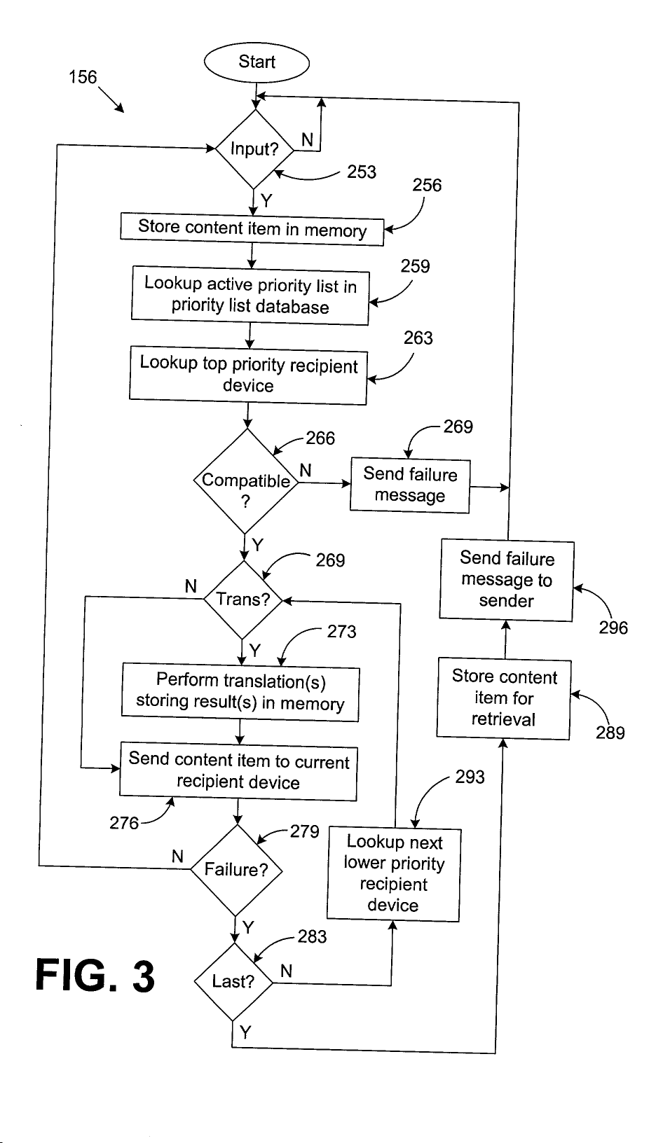

Turning next to FIG. 3, shown is a flow chart of the content relay system 156 according to an aspect of the present invention. Alternatively, the flow chart depicted in FIG. 3 may be viewed as depicting steps in a method implemented in the content relay server 103. As described before, the content relay system 156 is implemented to relay various content items transmitted from the sending device 136 (FIG. 1) to a user by way of one of the recipient devices 209 (FIG. 2) listed in the active priority list 223 (FIG. 2).

Beginning with block 253, the content relay system 156 determines whether a content item has been received from the sending device 136 via the network 109 (FIG. 1)/telecommunications network 113 (FIG. 1). If such is the case then the content relay system 156 proceeds to block 256 in which the content item is stored in the memory 146 (FIG. 1) of the content relay server 103 (FIG. 1). In particular, the memory device employed may be a hard drive, random access memory, or other memory storage device. Thereafter, the content relay system 156 proceeds to block 259 in which the active priority list 203 (FIG. 2) associated with the intended recipient is looked up from the priority list database 159 (FIG. 1). Thereafter, in block 263, the content relay system 156 identifies the top priority recipient device 209 (FIG. 2) to which the content item is to be transmitted.

The content relay system 156 then proceeds to block 266 in which it is determined whether the content item that has been received is in the form of one of the various input formats that the content relay system 156 can accept. For example, the content relay system 156 may accept content items that are in text format, audio files of predefined formats, or content items in other formats depending on the specific implementation of the content relay system 156. If the content item received is not compatible with the content relay system 156, then the content relay system 156 proceeds to block 269 in which a failure message is transmitted to the intended recipient by way of the recipient device 209 with the highest priority indicated in the current active priority list 223. The failure message informs the user that a message was received that was incompatible with the content relay system 156. In addition, the content item is refused from the sending device 136. Thereafter, the content relay system 156 reverts back to block 253.

Assuming however that the content item is compatible with the content relay system 156, then the content relay system 156 proceeds to block 269 in which it is determined whether the content item must be translated into a different format so as to be compatible with the recipient device 209 that is at the top of the active priority list 223. If a translation is required, then the content relay system 156 proceeds to block 273 in which necessary translations are performed and the resulting translated content item is once again stored in the memory 146. The translations may include various translating systems known by those with ordinary skill in the art such as, for example, voice synthesis for translation from text to an audio file, speech recognition for translation of an audio file to a text file, character recognition for translating a facsimile to text or other types of translations or combinations of translations.

Thereafter, the content relay system 156 proceeds to block 276 in which the content item is sent to the recipient device 209 that is at the top of the active priority list 223. The content relay system 156 also proceeds to block 276 from block 269 if no translation is necessary. Thereafter, in block 279, the content relay system 156 determines whether a failure has occurred in the attempt to send the content item to the top priority recipient device 209. Such might be the case, for example, if an intended delivery to a telephone or a cellular phone is made and the telephone or cellular phone is busy or unavailable for other reasons. In the case of email, the transmission might be sent back due to technical difficulties. Also, the recipient device 209 may be disabled for one of a number of reasons. Assuming that no failure occurs in block 279 and that the content item was successfully transmitted to the intended top priority recipient device 209, then the content relay system 156 reverts back to block 253.

However, if a failure has occurred in block 279, then the content relay system 156 proceeds to block 283 in which it is determined whether the last recipient device 209 to which an attempt was made to send the content item is the last recipient device 209 and the lowest priority on the active priority list 223. If such is the case then the content relay system 156 proceeds to block 289. Otherwise, the content relay system 156 moves to block 293. In block 293 the next lower priority recipient device 209 is looked up in the active priority list 223. Thereafter, the content relay system reverts back to block 269 to repeat the attempt to transmit the content item as before, but to the next identified lower priority recipient device 209.

In the case that the content relay system 156 proceeds to block 289, then an attempt has been made to transmit the content item to all of the recipient devices 209 in the active priority list 223, but none were successful. In such case, the content item is then stored in the memory 146 for later retrieval and then the content relay system 156 proceeds to block 296 in which the failure message is sent to the sending device 136 indicating that all attempts to transmit the content item to the recipient devices 209 listed in the active priority list 223 were unsuccessful. Thereafter, the content relay system 156 reverts to block 253 as shown.

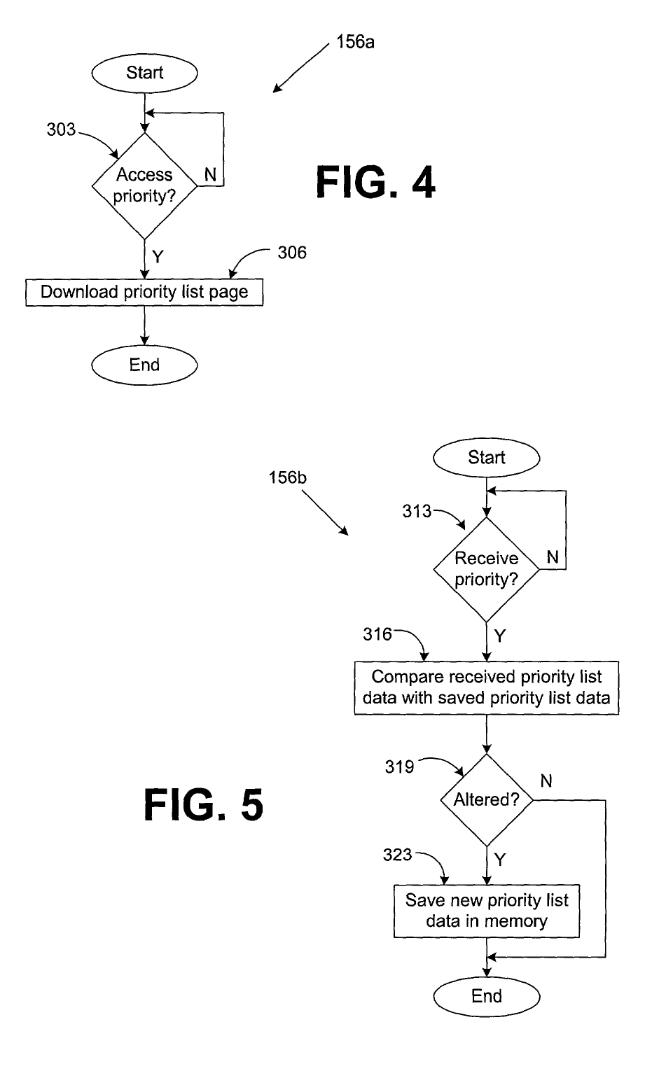

Referring next to FIG. 4, shown is a flow chart of a second component of the content relay system 156a according to an aspect of the present invention. Alternatively, the flow chart of FIG. 4 may be viewed as depicting steps in a method implemented in the content relay server 103. Beginning with block 303, the content relay system 156a determines whether the user has attempted to access their priority lists 203 via the graphical user interface 196 (FIG. 2). In particular, the content relay system 156a knows this has occurred when a request for the uniform resource locator of the content relay system 156 is received from the browser 189 (FIG. 1) of the client 106 (FIG. 1). Alternatively, in the case that a mini-browser or other such device is employed, various components of the graphical user interface 196 such as the active priority list indicator 223 may be downloaded commensurate with the capabilities of the mini-browser or other such device. As an additional alternative, an audio interface may be employed to provide user access to the priority lists 209 as previously described. Thereafter, in block 306, the graphical user interface 196 is downloaded to the client 106 for display on the display device 173 so that the user may manipulate it appropriately. Then, the content relay system 156a ends accordingly.

Referring next to FIG. 5, shown is a flow chart of a third component of the content relay system 156b according to an aspect of the present invention. Alternatively, the flow chart of FIG. 5 may be viewed as steps in a method implemented in the content relay server 103 (FIG. 1). The content relay system 156b is executed by the processor 143 to update any priority lists 203 (FIG. 2) that are stored in the priority list database 159 (FIG. 1) that have been altered by the user by manipulating the graphical user interface 196 (FIG. 2).

Beginning with block 313, the content relay system 156 determines whether updated priority lists 203 have been received from the client 106. This occurs when the user clicks on the done button 243 in the graphical user interface 196. Thereafter, the content relay system 156b proceeds to block 316 in which the priority list data that includes all of the priority lists 203 associated with a particular user are compared with the same priority lists 203 stored in the priority list database 159. Thereafter in block 319, the content relay system 156 detects whether there are any alterations. If such is the case then the content relay system 156 proceeds to block 323 in which the new priority list data is stored in the priority list database 159, thereby replacing the previously stored priority lists 203. Thereafter, the content relay system 156b ends. Referring back to block 319, if no alterations are detected, then the content relay system 156 ends accordingly. Thus the content relay system 156b ensures that any changes made by the user in manipulating the graphical user interface 196 are stored in the priority list database 159 accordingly.

Although the content relay system 156 (FIGS. 3-5) of the present invention is embodied in software executed by general purpose hardware as discussed above, as an alternative the content relay system 156 may also be embodied in dedicated hardware or a combination of software/general purpose hardware and dedicated hardware. If embodied in dedicated hardware, the content relay system 156 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flow charts of FIGS. 3-5 show the architecture, functionality, and operation of an implementation of the content relay system 156. If embodied in software, each block may represent a module, segment, or portion of code that comprises one or more action statements in the form of executable instructions or declarations to implement the specified logical function(s). If embodied in hardware, each block may represent a circuit or a number of interconnected circuits to implement the specified logical function(s). Although the flow charts of FIGS. 3-5 show a specific order of execution, it is understood that the order of execution may differ from that which is depicted. For example, the order of execution of two or more blocks may be scrambled relative to the order shown. Also, two or more blocks shown in succession in FIGS. 3-5 may be executed concurrently or with partial concurrence. It is understood that all such variations are within the scope of the present invention. Also, the flow charts of FIGS. 3-5 are relatively self-explanatory and are understood by those with ordinary skill in the art to the extent that software and/or hardware can be created by one with ordinary skill in the art to carry out the various logical functions as described herein.

Also, the content relay system 156 can be embodied in any computer-readable medium for use by or in connection with an instruction execution system such as a computer/processor based system or other system that can fetch or obtain the logic from the computer-readable medium and execute the action statements including the instructions contained therein. In the context of this document, a “computer-readable medium” can be any medium that can contain, store, or maintain the content relay system 156 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as floppy diskettes or hard drives, a random access memory (RAM), a read-only memory (ROM), an erasable programmable read-only memory, or a portable compact disc.

Although the invention is shown and described with respect to certain preferred embodiments, it is obvious that equivalents and modifications will occur to others skilled in the art upon the reading and understanding of the specification. The present invention includes all such equivalents and modifications, and is limited only by the scope of the claims.

I/We claim:

1. A method for relaying a content item, comprising:
storing the content item in a first format received from a sending device in a memory of a content relay server;
identifying a select one of a number of recipient devices according to a predefined priority to receive the content item; and
transmitting the content item to the select one of the recipient devices from the content relay server.

2. The method of claim 1, further comprising identifying a subsequent one of the number of recipient devices according to the predefined priority to receive the content item upon a failure to transmit the content item to a prior selected one of the recipient devices.

3. The method of claim 1, further comprising translating the content item from the first format into a second format, the second format being compatible with the select one of the recipient devices.

4. The method of claim 3, wherein the step of transmitting the content item to the select one of the recipient devices further comprises transmitting the content item to the select one of the recipient devices in the second format.

5. The method of claim 1, wherein the step of identifying the select one of the number of recipient devices according to the predefined priority to receive the content item further comprises:
storing a number of priority lists associated with a user in the memory;
designating one of the priority lists as an active priority list; and
employing the active priority list as the predefined priority.

6. The method of claim 5, wherein the step of designating one of the priority lists as the active priority list further comprises designating one of the priority lists as the active priority list based upon a user selection.

7. A method for relaying a content item, comprising:
storing the content item in a first format received from a sending device in a memory;
storing a number of priority lists associated with a user in the memory, each of the priority lists identifying a number of recipient devices;
designating one of the priority lists as an active priority list;
identifying a select one of the recipient devices according to the active priority list to receive the content item;
translating the content item from a first format into a second format, the second format being compatible with the select one of the recipient devices; and
attempting to transmit the content item to the select one of the recipient devices.

8. A system for relaying a content item, comprising:
a processor circuit with a processor and a memory;
a content relay system stored in the memory and executable by the processor, the content relay system comprising:
logic for storing the content item in a first format received from a sending device in the memory;
logic for identifying a select one of a number of recipient devices according to a predefined priority to receive the content item; and
logic for transmitting the content item to the select one of the recipient devices.

9. The system of claim 8, wherein the content relay system further comprises logic for identifying a subsequent one of the number of recipient devices according to the predefined priority to receive the content item upon a failure to transmit the content item to a prior selected one of the recipient devices.

10. The system of claim 8, wherein the content relay system further comprises logic for translating the content item from the first format into a second format, the second format being compatible with the select one of the recipient devices.

11. The system of claim 10, wherein the logic for transmitting the content item to the select one of the recipient devices further comprises logic for transmitting the content item to the select one of the recipient devices in the second format.

12. The system of claim 8, wherein the logic for identifying the select one of the number of recipient devices according to the predefined priority to receive the content item further comprises:
logic for maintaining a number of priority lists associated with a user in the memory;
logic for designating one of the priority lists as an active priority list; and
logic for employing the active priority list as the predefined priority.

13. The system of claim 12, wherein the logic for designating one of the priority lists as the active priority list further comprises logic for designating one of the priority lists as the active priority list based upon a user selection.

14. A system for relaying a content item, comprising:
a processor circuit with a processor and a memory;
a content relay system stored in the memory and executable by the processor, the content relay system comprising:
logic for storing the content item in a first format received from a sending device in the memory;
logic for maintaining a number of priority lists associated with a user in the memory, each of the priority lists identifying a number of recipient devices;
logic for designating one of the priority lists as an active priority list;
logic for identifying a select one of the recipient devices according to the active priority list to receive the content item;
translating the content item from a first format into a second format, the second format being compatible with the select one of the recipient devices; and
attempting to transmit the content item to the select one of the recipient devices.

15. A system for relaying a content item, comprising:
means for storing the content item in a first format received from a sending device in a memory of a content relay server;
means for identifying a select one of a number of recipient devices according to a predefined priority to receive the content item; and
means for transmitting the content item to the select one of the recipient devices from the content relay server.

16. The system of claim 15, further comprising means for identifying a subsequent one of the number of recipient devices according to the predefined priority to receive the content item upon a failure to transmit the content item to a prior selected one of the recipient devices.

17. The system of claim 15, further comprising means for translating the content item from the first format into a second format, the second format being compatible with the select one of the recipient devices.

18. The system of claim 17, wherein the means for transmitting the content item to the select one of the recipient devices further comprises means for transmitting the content item to the select one of the recipient devices in the second format.

19. The system of claim 15, wherein the means for identifying the select one of the number of recipient devices according to the predefined priority to receive the content item further comprises:
means for maintaining a number of priority lists associated with a user in the memory;
means for designating one of the priority lists as an active priority list; and
means for employing the active priority list as the predefined priority.

20. The system of claim 19, wherein the means for designating one of the priority lists as the active priority list further comprises means for designating one of the priority lists as the active priority list based upon a user selection.
